(19) United States
(12) Patent Application Publication
(10) Pub. No.: US 2004/0246641 A1
(43) Pub. Date: Dec. 9, 2004

(54) Inverter control unit for motor driving and air-conditioner employing the same

(76) Inventors: Tomohiro Sugimoto, Kusatsu-shi (JP); Hideo Matsushiro, Kusatsu-shi (JP); Mitsuo Kawaji, Sakata-gun (JP); Akihiro Kyogoku, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/827,289

(22) Filed: Apr. 20, 2004

(30) Foreign Application Priority Data
Apr. 28, 2003 (JP) 2003-123042
Apr. 8, 2004 (JP) 2004-114497

(51) Int. Cl. H02H 7/125

(52) U.S. Cl. 361/91.1

(57) ABSTRACT

An inverter control unit for motor driving includes a rectifier circuit for converting into a DC power a first AC power inputted from an AC power supply, which includes a diode bridge and a reactor connected to an AC input side or a DC output side of the diode bridge and having a small inductance, and an inverter for converting the DC power from the rectifier circuit into a second AC power so as to output the second AC power to a motor. Furthermore, a capacitor for absorbing regenerative energy of the motor, which has a small capacitance and an overvoltage protecting circuit whose impedance is lowered by overvoltage are connected between DC buses of the inverter.

### BACKGROUND OF THE INVENTION

1. Field of the Invention

The present invention relates to an inverter control unit for motor driving, which includes a small-inductance reactor and a small-capacitance capacitor and an air-conditioner employing this inverter control unit.

2. Description of the Prior Art

Various rectification methods employing diodes are hitherto known. For example, a prior art DC power supply device proposed in Japanese Patent Laid-Open Publication No. 9-266674 (1997) is shown in FIG. 8. Operation of the prior art DC power supply device is described below. In FIG. 8, an AC supply voltage of an AC power supply 1 is applied to an AC input terminal of a full-wave rectifier circuit having bridge connection of diodes D1 to D4. An output of the full-wave rectifier circuit is applied to an intermediate capacitor C via a reactor Lin and electric charge of the intermediate capacitor C is discharged to a smoothing capacitor CD such that a DC voltage is supplied to a load resistance RL. In this case, at a load side of the reactor Lin, a transistor Q1 is connected to positive and negative DC paths connecting the full-wave rectifier circuit and the intermediate capacitor C such that the transistor Q1 is driven by a base driving circuit G1.

Meanwhile, pulse generators PG1 and PG2 for applying a pulse voltage to the base driving circuit G1 and a dummy resistance Rdm are provided. The pulse generator PG1 is formed by a circuit for detecting a zero-cross point of the AC supply voltage, while the pulse generator PG2 is formed by a pulse current circuit for causing pulse current to flow through the dummy resistance Rdm until an instantaneous value of the AC supply voltage coincides with a voltage across the intermediate capacitor C after detection of the zero-cross point. Here, the pulse generator PG1 is adapted to generate pulse voltage in a first half of a half cycle of the AC supply voltage, while the pulse generator PG2 is adapted to generate pulse voltage in a second half of the half cycle of the AC supply voltage. In case electric current is caused to flow through the reactor Lin forcedly by turning on the transistor Q1, a reverse current preventing diode D5 is connected such that electric charge of the intermediate capacitor C is not discharged by way of the transistor Q1. Furthermore, a reverse flow preventing diode D6 and a reactor Ldc for enhancing smoothing effect are inserted in series in a path for discharging electric charge of the intermediate capacitor C to the smoothing capacitor CD.

By the above described configuration, when the transistor Q1 is held in ON state in a portion or a whole of a phase interval in which the instantaneous value of the AC supply voltage does not exceed the voltage across the intermediate capacitor C, higher harmonic component can be reduced and high power-factor can be gained while the prior art DC power supply device is prevented from becoming large in size.

However, in the above described configuration, since the smoothing capacitor CD having a large capacitance of 1500 μF, the reactor Lin having a large inductance of 6.2 mH, the intermediate capacitor C, the transistor Q1, the base driving circuit G1, the pulse generators PG1 and PG2, the dummy resistance Rdm, the reverse current preventing diodes D5 and D6 and the reactor Ldc for enhancing smoothing effect are provided, the prior art DC power supply device becomes large in size and the number of components of the prior art power supply device increases, thereby resulting in rise of production cost of the prior art power supply device.

Thus, such an inverter control unit for motor driving as shown in FIG. 5 has begun to arouse public attention. In FIG. 5, the conventional inverter control unit includes a rectifier circuit having an AC power supply 1 at its input, an inverter 10 for converting DC power into AC power and a motor 11. The rectifier circuit is constituted by a diode bridge 6 and a reactor 9 having a quite small inductance, which is connected to an AC input side or a DC output side of the diode bridge 6. A capacitor 7 for absorbing regenerative energy of the motor 11, which has a quite small capacitance, is connected between DC buses of the inverter 10.

In the above described configuration of the conventional inverter control unit, even if it is difficult to drive the motor 11 due to large variations of inverter DC voltage upon establishment of inverter control, the inverter 10 can be operated such that voltage applied to the motor 11 is kept substantially constant. Namely, since the motor 11 can be driven by using the small-inductance reactor 9 and the small-capacitance capacitor 7, the conventional inverter control unit can be not only made small in size and light in weight but produced at low cost.

On the other hand, methods of suppressing rise of DC voltage at the time of motor regeneration are hitherto known. For example, a known motor control device proposed in Japanese Patent Laid-Open Publication No. 10-136674 (1998) is shown in FIG. 9. The known motor control device of FIG. 9 includes a power rectifier 32 for converting AC voltage from an AC power supply 31 into DC voltage by a diode bridge or the like. Meanwhile, a first switching element 33 and a smoothing capacitor 35 which are connected to each other in series and a resistor 36 and a regenerative transistor 37 which are connected to each other in series are connected to an output terminal of the power rectifier 32. The known motor control device further includes a second switching element 34 for charging the smoothing capacitor 35 via the resistor 36 at the time of turning on of the power supply 31, a voltage detecting circuit 38 for detecting a DC voltage across the smoothing capacitor 35 and a switch control circuit 39 for performing on-off control of the first switching element 33, the second switching element 34 and the regenerative transistor 37 separately in response to a voltage signal detected by the voltage detecting circuit 38.

At the time the power supply 31 is turned on in the known motor control device, the first and second switching elements 33 and 34 are, respectively, turned off and on by the switch control circuit 39. Thus, the second switching element 34 charges the smoothing capacitor 35 via the resistor 36 so as to restrict rush current. Therefore, at this time, the resistor 36 functions as a rush current preventing resistor.

Meanwhile, during ordinary operation of the known motor control device, the first and second switching elements 33 and 34 are, respectively, turned on and off by the switch control circuit 39 and thus, heat generation of the resistor 36 can be prevented.

Furthermore, at the time of regeneration of the known motor control device, the regenerative transistor 37 is turned on so as to discharge electric charge of the smoothing capacitor 35 by way of the resistor 36. Namely, electric charge of the smoothing capacitor 35 is consumed at the resistor 36. Thus, if the DC voltage across the smoothing capacitor 35 drops to a predetermined value or less, the regenerative transistor 37 is turned off so as to suppress rise of DC voltage. Therefore, at this time, the resistor 36 functions as a regenerative braking resistor.

Accordingly, by the above described configuration of the known motor control device, since the single resistor 36 can be used not only as the rush current preventing resistor but as the regenerative braking resistor, the large resistor can be eliminated, so that known motor control device can be not only made compact in size and light in weight but produced at low cost.

However, in the conventional inverter control unit employing the small-inductance reactor 9 and the small-capacitance capacitor 7 as shown in FIG. 5, when the motor 11 has been stopped, regenerative energy of the motor 11 is absorbed by the small-capacitance capacitor 7. In case the regenerative energy is large, rise of DC voltage is large due to the quite small capacitance of the capacitor 7. Meanwhile, in the known motor control device employing the resistor 36 acting not only as the rush current preventing resistor but as the regenerative braking resistor as shown in FIG. 9, since regenerative energy cannot be absorbed prior to breakdown of each of the driver elements, the regenerative energy exceeds a breakdown voltage of each driver element, thereby resulting in puncture of each driver element disadvantageously. In this specification, the term “breakdown” is used to mean a phenomenon in which when a voltage applied to a diode in its reverse direction has exceeded a predetermined value, the diode loses its capability for blocking inverse current, thus resulting in abrupt start of flow of the inverse current through the diode.

### SUMMARY OF THE INVENTION

Accordingly, an essential object of the present invention is to provide, with a view to eliminating the above mentioned drawbacks of prior art, an inverter control unit for motor driving, in which a DC voltage can be restricted to not more than a breakdown voltage of each of driver elements, and an air-conditioner employing this inverter control unit.

In order to accomplish this object of the present invention, an inverter control unit for motor driving, according to the present invention includes a rectifier circuit for converting into a DC power a first AC power inputted from an AC power supply, which includes a diode bridge and a reactor connected to an AC input side or a DC output side of the diode bridge and having a small inductance and the diode bridge has a plurality of first driver elements. An inverter converts the DC power from the rectifier circuit into a second AC power so as to output the second AC power to a motor and includes a plurality of second driver elements. Furthermore, a capacitor for absorbing regenerative energy of the motor is connected between DC buses of the inverter and has a small capacitance. An overvoltage protecting circuit is connected between the DC buses of the inverter in parallel with the capacitor so as to be actuated prior to breakdown of the first driver elements of the diode bridge and the second driver elements of the inverter.

By the above described configuration of the inverter control unit, even if voltage between the DC buses is raised by regenerative energy produced upon stop of the motor, the voltage between the DC buses can be restricted to not more than a breakdown voltage of the first and second driver elements by the overvoltage protecting circuit which is actuated at a set voltage.

### BRIEF DESCRIPTION OF THE DRAWINGS

This object and features of the present invention will become apparent from the following description taken in conjunction with the preferred embodiments thereof with reference to the accompanying drawings in which:

FIG. 1 is a circuit diagram showing a configuration of an inverter control unit for motor driving, according to a first embodiment of the present invention;

FIG. 2 is a circuit diagram showing a configuration of an inverter control unit for motor driving, according to a second embodiment of the present invention;

FIG. 3 is a graph showing waveforms of DC voltage Vdc and regenerative current 11 from the motor in the inverter control unit of FIG. 2;

FIG. 4 is a circuit diagram showing a configuration of an air-conditioner according to a third embodiment of the present invention, which includes the inverter control unit of FIG. 1 or FIG. 2;

FIG. 5 is a circuit diagram showing a configuration of a conventional inverter control unit for motor driving, which includes a small-inductance reactor and a small-capacitance capacitor;

FIGS. 6A and 6B are views explanatory of operation of the conventional inverter control unit of FIG. 5;

FIG. 7 is a graph showing waveforms of DC voltage Vdc and regenerative current 11 from the motor in the conventional inverter control unit of FIG. 5;

FIG. 8 is a circuit diagram of a prior art DC power supply device; and

FIG. 9 is a circuit diagram of a known motor control device.

Before the description of the present invention proceeds, it is to be noted that like parts are designated by like reference numerals throughout several views of the accompanying drawings.

### DETAILED DESCRIPTION OF THE INVENTION

Hereinafter, embodiments of the present invention are described with reference to the drawings.

### First Embodiment

FIG. 1 shows a configuration of an inverter control unit 100A for motor driving, according to a first embodiment of the present invention. The inverter control unit 100A includes a bridge rectifier circuit 6 for performing full-wave rectification of AC from an AC power supply 1, which is formed by four diodes 2 to 5, a small-inductance reactor 9 connected to an AC input side of the bridge rectifier circuit 6, a three-phase bridge type inverter 10 for converting DC power into AC power, a capacitor 7 for absorbing regenerative energy of a motor 11, which is connected to DC buses of the bridge rectifier circuit 6 and has a quite small capacitance and an overvoltage protecting circuit 8A which is connected to the DC buses of the bridge rectifier circuit 6 in parallel with the small-capacitance capacitor 7 so as to be actuated prior to breakdown of driver elements of the bridge rectifier circuit 6 and the inverter 10. An output of the inverter 10 is supplied to the motor 11. Meanwhile, the small-inductance reactor 9 may also be disposed between an AC output terminal and the small-capacitance capacitor 7.

When a voltage applied to the overvoltage protecting circuit 8A has exceeded its predetermined voltage, the overvoltage protecting circuit 8A is adapted to lower its impedance so as to bypass electric current thereinto. In this embodiment, the overvoltage protecting circuit 8A is formed by a surge absorber 12 acting as a voltage absorbing element.

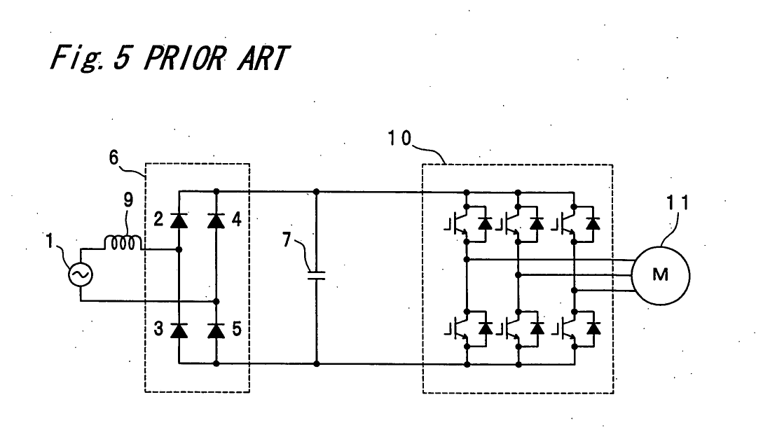

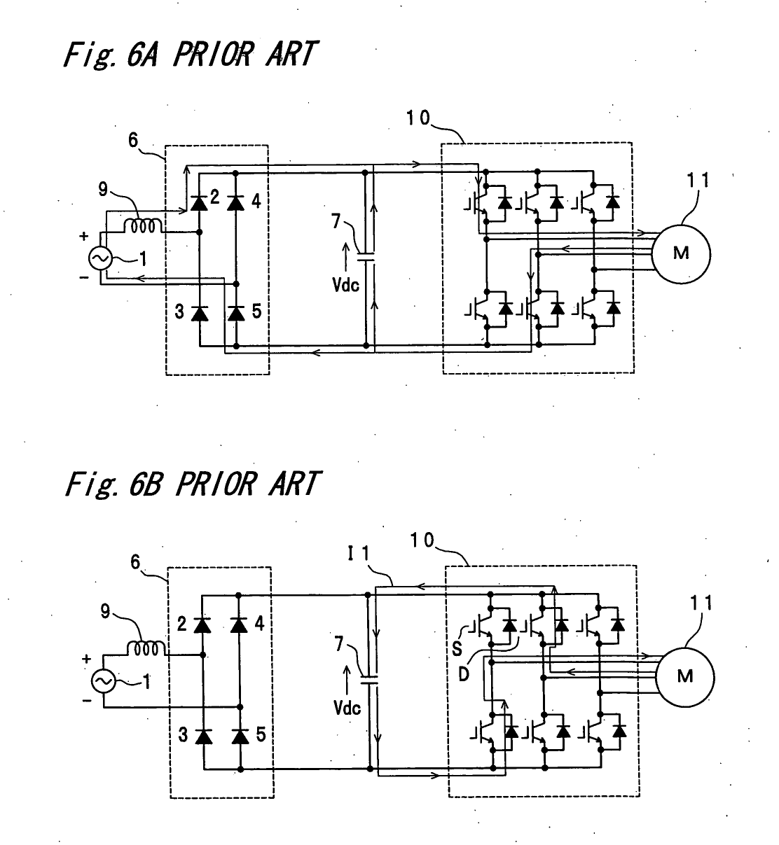

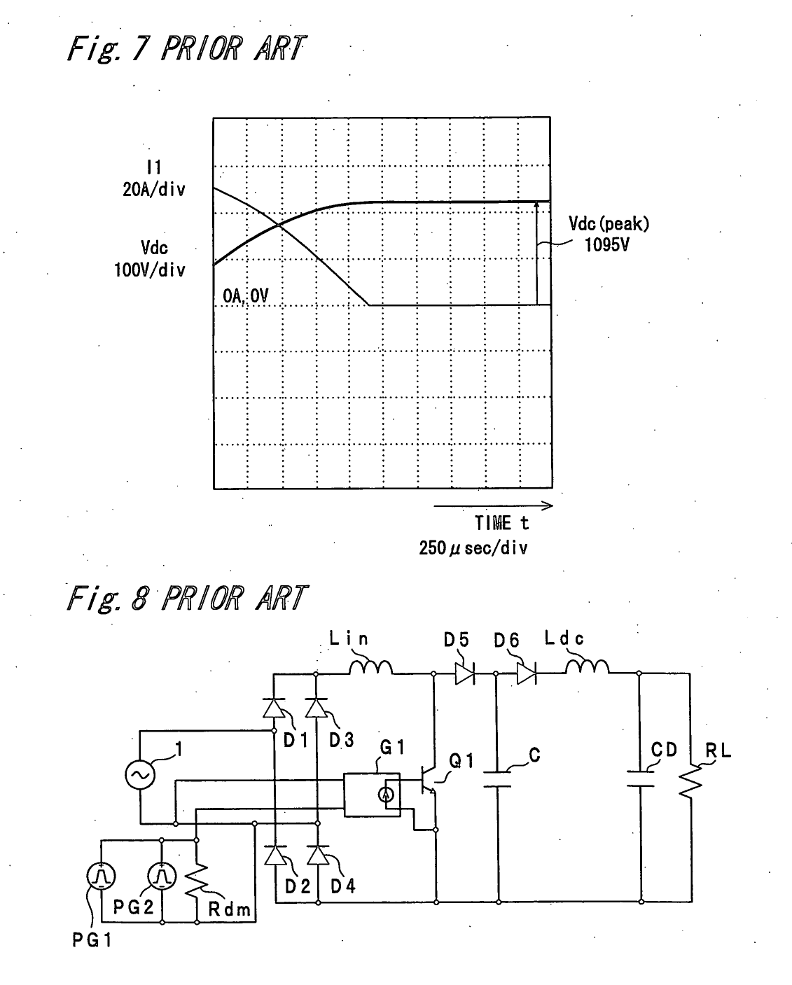

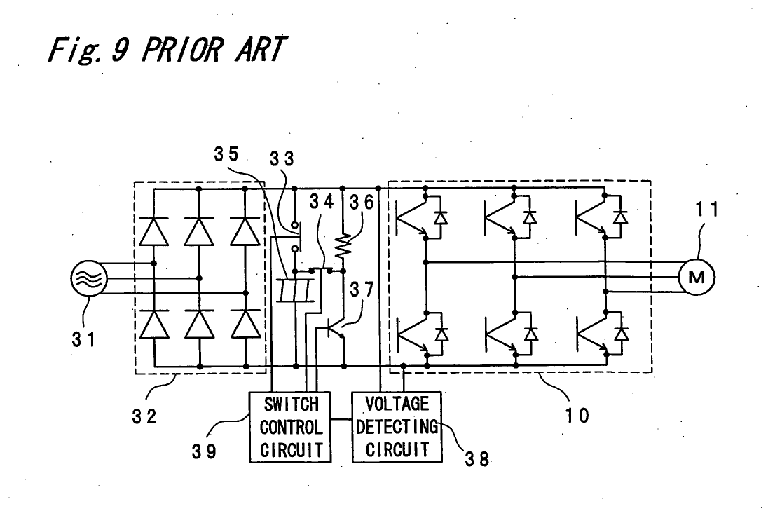

Before operation of the inverter control unit 100A is described, operation of a conventional inverter control unit (FIG. 5) including a small-inductance reactor 9 and a small-capacitance capacitor 7 at the time of stop of a motor 11 is described with reference to FIGS. 6A and 6B. In the conventional inverter control unit, in case the motor is operated normally, electric current flows in the direction of the arrow shown in FIG. 6A. On the other hand, in case the motor 11 is stopped, magnetic energy accumulated by inductance component of the motor 11 is turned into regenerative energy and thus, regenerative current I1 flows in the direction of the arrow shown in FIG. 6B via diodes D connected to switching elements S in parallel, respectively in the inverter 10 so as to charge the small-capacitance capacitor 7, thereby resulting in increase of its charging voltage, i.e., a line voltage Vdc across DC buses. Since the line voltage Vdc (peak) amounts to 1095 V as shown in FIG. 7 and thus, exceeds a breakdown voltage of 600 V of the small-capacitance capacitor 7 and the inverter 10, thereby resulting in breakdown of the small-capacitance capacitor 7 and the inverter 10. Meanwhile, FIG. 7 shows waveforms of the line voltage Vdc and the regenerative current I1 obtained under conditions that a maximum current flowing through the motor 11 at the time of stop of the motor 11 is 51A and the small-capacitance capacitor 7 has a capacitance of 10 μF.

On the other hand, in the inverter control unit 100A of the present invention shown in FIG. 1, when a line voltage Vdc has reached a preset DC voltage, the surge absorber 12 functions such that regenerative current I1 flows through the surge absorber 12 as shown by the arrow in FIG. 1, thereby resulting in suppression of rise of the line voltage Vdc. A suppressed voltage achieved by the surge absorber 12 is so set as to be not more than a breakdown voltage of the small-capacitance capacitor 7 and the inverter 10. Meanwhile, the surge absorber 12 acting as the overvoltage protecting circuit 8A should have a function of interrupting dynamic current if a voltage applied thereto drops lower than a predetermined value and may be formed by a selenium absorber employing a selenium rectifier.

Therefore, in the inverter control unit 100A of this embodiment, since the line voltage Vdc which is raised by regenerative energy of the motor 11 at the time of stop of the motor 11 can be set lower than the breakdown voltage of the small-capacitance capacitor 7 and the inverter 10 by the overvoltage protecting circuit 8A, it is possible to prevent breakdown of the small-capacitance capacitor 7 and the inverter 10 due to overvoltage.

### Second Embodiment

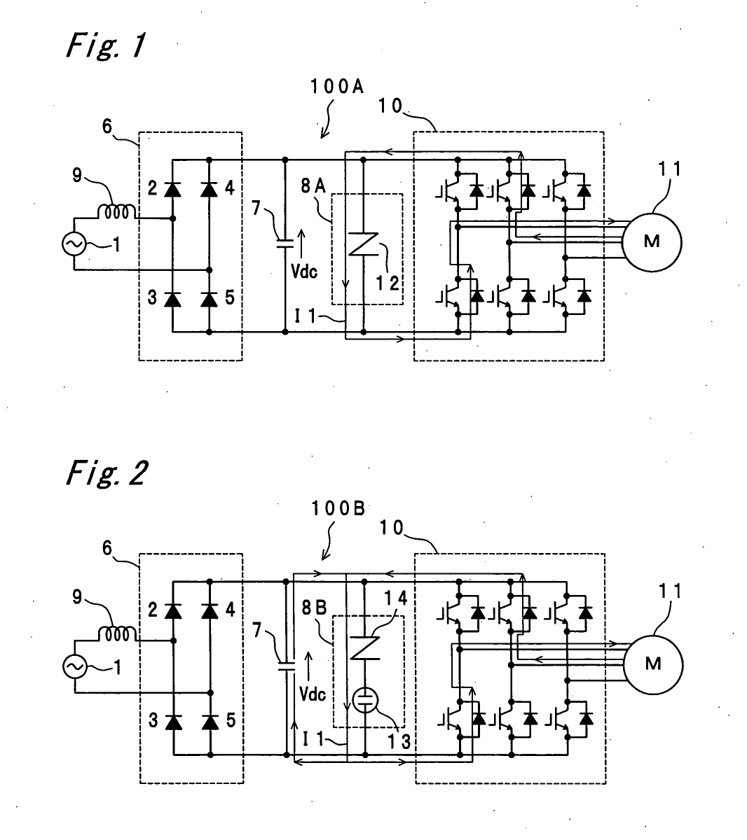

FIG. 2 shows a configuration of an inverter control unit 100B for motor driving, according to a second embodiment of the present invention. In the inverter control unit 100B, an overvoltage protecting circuit 8B is employed in place of the overvoltage protecting circuit 8A of the inverter control unit 100A of the first embodiment. The overvoltage protecting circuit 8B includes a gas arrester 13 acting as a voltage discharging element and a surge absorber 14 for interrupting dynamic current, which is connected to the gas arrester 13 in series. Since other arrangements of the inverter control unit 100B are similar to those of the inverter control unit 100A, the description is abbreviated for the sake of brevity.

In the inverter control unit 100B of FIG. 2, when the line voltage Vdc has reached a predetermined value upon charging of the small-capacitance capacitor 7, discharge occurs at the gas arrester 13. As a result, the motor current 11 based on regenerative energy and electric current from the charged small-capacitance capacitor 7 flow in directions of the arrows shown in FIG. 2.

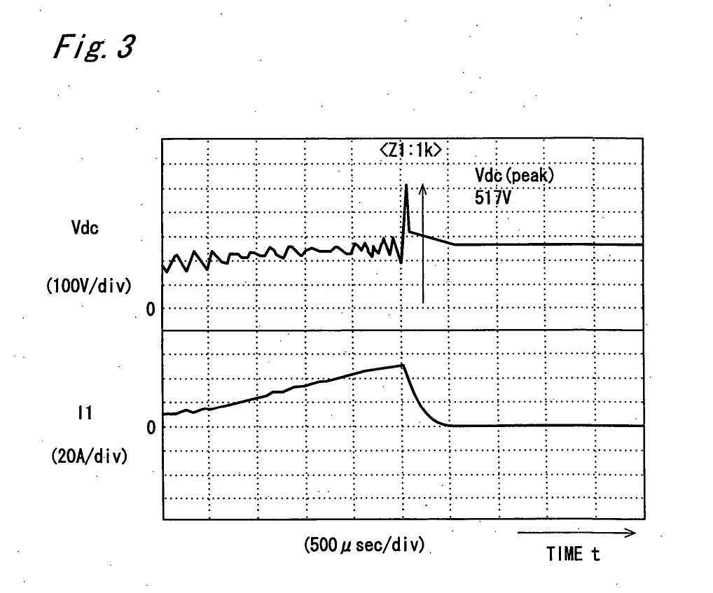

Supposing here that the AC power supply 1 has a voltage of 220 V, the small-inductance reactor 9 has an inductance of 0.5 mH, the small-capacitance capacitor 7 has a capacitance of 10 μF, a maximum value of electric current flowing through the motor 11 at the time of stop of the motor 11 is 51 A and a voltage for starting discharge of the gas arrester 13 is 500 V, the DC voltage Vdc and the regenerative current 11 from the motor 11 have waveforms shown in FIG. 3. As shown in FIG. 3, the line voltage Vdc is restricted to 517 V by discharge of the gas arrester 13 and thus, can be set lower than a breakdown voltage of 600 V of the small-capacitance capacitor 7 and the inverter 10. Once discharge occurs at the gas arrester 13, discharge continues at the gas arrester 13 even if the line voltage Vdc has dropped below the voltage for starting discharge of the gas arrester 13. However, when the line voltage Vdc has dropped to a certain voltage, the surge absorber 14 is operated so as to interrupt dynamic current.

Therefore, also in the inverter control unit 100B of this embodiment, since the line voltage Vdc which is raised by regenerative energy of the motor 11 at the time of stop of the motor 11 can be set lower than the breakdown voltage of the small-capacitance capacitor 7 and the inverter 10 by the overvoltage protecting circuit 8B, it is possible to prevent breakdown of the small-capacitance capacitor 7 and the inverter 10 due to overvoltage.

### Third Embodiment

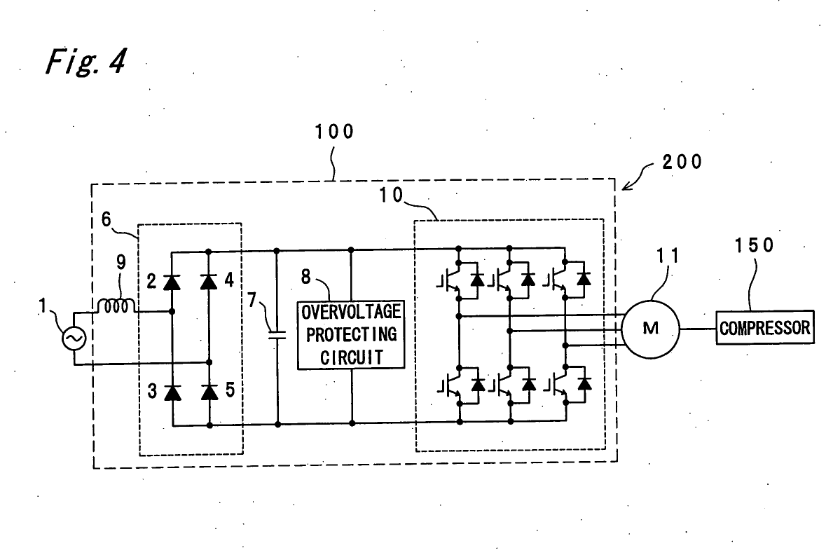

FIG. 4 shows a configuration of an air-conditioner 200 according to a third embodiment of the present invention, which includes an inverter control unit 100 for motor driving. The inverter control unit 100 is formed by the inverter control unit 100A of the first embodiment or the inverter control unit 100B of the second embodiment. Thus, an overvoltage protecting circuit 8 of the inverter control unit 100 acts as the overvoltage protecting circuit 8A of the inverter control unit 100A or the overvoltage protecting circuit 8B of the inverter control unit 100B. In addition, a compressor 150 is coupled with the motor 11.

In the air-conditioner 200, since the inverter control unit 100A of the first embodiment or the inverter control unit 100B of the second embodiment is used as the inverter control unit 100, the line voltage which is raised by regenerative energy of the motor 11 at the time of stop of the motor 11 can be set lower than the breakdown voltage of the small-capacitance capacitor 7 and the inverter 10 by the overvoltage protecting circuit 8 acting as the overvoltage protecting circuit 8A of the inverter control unit 100A or the overvoltage protecting circuit 8B of the inverter control unit 100B.

Therefore, in the air-conditioner 200 of this embodiment, since the overvoltage protecting circuit 8 of the inverter control unit 100 is capable of preventing breakdown of the small-capacitance capacitor 7 and the inverter 10 due to overvoltage, the compressor 15 is stably operated by the motor 11 at all times, so that operational reliability of the air-conditioner 200 can be upgraded greatly.

As is clear from the foregoing description, since the overvoltage protecting circuit for protecting the line voltage of the DC buses from overvoltage is provided in the inverter control unit including the small-inductance reactor and the small-capacitance capacitor, according to the present invention, the line voltage which is raised by regenerative energy of the motor at the time of stop of the motor can be set lower than the breakdown voltage of the driver elements by the overvoltage protecting circuit, so that it is possible to prevent breakdown of the driver elements due to overvoltage.

Meanwhile, in the air-conditioner of the present invention, which is provided with the above inverter control unit, since the compressor is stably operated at all times by the motor, operational reliability of the air-conditioner can be upgraded greatly.

What is claimed is:

1. An inverter control unit for motor driving, comprising:
a rectifier circuit for converting into a DC power a first AC power inputted from an AC power supply, which includes a diode bridge and a reactor connected to an AC input side or a DC output side of the diode bridge and having a small inductance, with the diode bridge having a plurality of first driver elements;
an inverter for converting the DC power from the rectifier circuit into a second AC power so as to output the second AC power to a motor, which includes a plurality of second driver elements;
a capacitor for absorbing regenerative energy of the motor, which is connected between DC buses of the inverter and has a small capacitance; and
an overvoltage protecting circuit which is connected between the DC buses of the inverter in parallel with the capacitor so as to be actuated prior to breakdown of the first driver elements of the diode bridge and the second driver elements of the inverter.

2. The inverter control unit as claimed in claim 1, wherein the overvoltage protecting circuit is formed by a surge absorber.

3. The inverter control unit as claimed in claim 1, wherein the overvoltage protecting circuit is formed by a surge absorber and a gas arrester connected to the surge absorber in series.

4. In an air-conditioner including an inverter control unit for driving a motor, the inverter control unit comprising: a rectifier circuit for converting into a DC power a first AC power inputted from an AC power supply, which includes a diode bridge and a reactor connected to an AC input side or a DC output side of the diode bridge and having a small inductance, with the diode bridge having a plurality of first driver elements; an inverter for converting the DC power from the rectifier circuit into a second AC power so as to output the second AC power to the motor, which includes a plurality of second driver elements; and a capacitor for absorbing regenerative energy of the motor, which is connected between DC buses of the inverter and has a small capacitance;
the improvement of the inverter control unit comprising:
an overvoltage protecting circuit which is connected between the DC buses of the inverter in parallel with the capacitor so as to be actuated prior to breakdown of the first driver elements of the diode bridge and the second driver elements of the inverter.

5. The air-conditioner as claimed in claim 4, wherein the overvoltage protecting circuit is formed by a surge absorber.

6. The air-conditioner as claimed in claim 4, wherein the overvoltage protecting circuit is formed by a surge absorber and a gas arrester connected to the surge absorber in series.
